(19) United States
(12) Patent Application Publication
(10) Pub. No.: US 2009/0115787 A1
(43) Pub. Date: May 7, 2009

(54) INFORMATION PROCESSING APPARATUS AND MOTION PICTURE DATA PROCESSING METHOD

(75) Inventor: Taku NARUSE, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/207,058

(22) Filed: Sep. 9, 2008

(30) Foreign Application Priority Data
Nov. 2, 2007 (JP) 2007-286577

(51) Int. Cl. G06T 1/00

(52) U.S. Cl. 345/501

(57) ABSTRACT

According to one embodiment, an information processing apparatus includes a storage device to store motion picture data, a dividing module which divides the motion picture data stored in the storage device into first motion picture data and second motion picture data, a transmitting module which transmits one of the first motion picture data and second motion picture data formed by the dividing module to another electronic apparatus, and a display module which displays one of the first motion picture data and second motion picture data formed by the dividing module while the one of the first motion picture data and second motion picture data is subjected to a predetermined adjusting process.

### CROSS-REFERENCE TO RELATED APPLICATIONS

This application is based upon and claims the benefit of priority from Japanese Patent Application No. 2007-286577, filed Nov. 2, 2007, the entire contents of which are incorporated herein by reference.

### BACKGROUND

1. Field

One embodiment of the invention relates to a motion picture data processing technique that is preferably applied to a personal computer or the like including a function of recording and playing back digital television broadcast program data, for example.

2. Description of the Related Art

Recently, various types of personal computers such as notebook size personal computers and desktop computers are widely used. In the above types of personal computers, it becomes common practice to provide functions of recording and playing back broadcast program data broadcast according to a television broadcast signal. Thus, for example, it becomes possible to record broadcast program data by use of a desktop personal computer that is called a home server, previously transmit desired broadcast program data selected from the above broadcast program data to a portable personal computer that is called a mobile computer as required. As a result, it becomes possible for the user to enjoy the desired broadcast program data in a place where he is going to or while he is moving.

Based on the above trend, various proposals relating to transmission or reception of motion picture data such as broadcast program data between an information processing apparatus and another electronic apparatus, for example, are made (for example, see Jpn. Pat. Appln. KOKAI Publication No. H10-174097).

Some broadcast program data among the broadcast program data broadcast according to a television broadcast signal are permitted to move between the information processing apparatus and another electronic apparatus, for example, but are limited from being completely copied from the view point of protection of the copyright. If the user wants to enjoy such broadcast program data by use of a home server at a certain time and enjoy the same by use of a mobile computer at anther time, it is necessary to move the broadcast program data between the home server and the mobile computer for each time and it is extremely inconvenient for the user.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to an embodiment of the invention;

FIG. 2 is an exemplary diagram showing the system configuration of the information processing apparatus of the embodiment;

FIG. 3 is an exemplary view for illustrating the outline of a motion picture data dividing function provided as one function of the TV functions of a TV application program that is executed on the information processing apparatus of the embodiment;

FIG. 4 is an exemplary diagram showing a function block of the TV application program that is executed on the information processing apparatus of the embodiment;

FIG. 5 is an exemplary diagram showing attribute information items of motion picture data items managed by the TV application program that is executed on the information processing apparatus of the embodiment;

FIG. 6 is an exemplary conceptual diagram showing the basic principle of division of motion picture data performed by a TV application program that is executed on the information processing apparatus of the embodiment;

FIG. 7 is an exemplary diagram showing the process of reversibly converting motion picture data by the TV application program that is executed on the information processing apparatus of the embodiment;

FIG. 8 is an exemplary flowchart for illustrating the procedure at the time of division of motion picture data by the TV application program that is executed on the information processing apparatus of the embodiment; and

FIG. 9 is an exemplary flowchart for illustrating the procedure at the time of restoration of motion picture data by the TV application that is executed on the information processing apparatus of the embodiment.

### DETAILED DESCRIPTION

Various embodiments according to the invention will be described hereinafter with reference to the accompanying drawings. In general, according to one embodiment of the invention, an information processing apparatus includes a storage device to store motion picture data, a dividing module which divides the motion picture data stored in the storage device into first motion picture data and second motion picture data, a transmitting module which transmits one of the first motion picture data and second motion picture data formed by the dividing module to another electronic apparatus; and a display module which displays one of the first motion picture data and second motion picture data formed by the dividing module while the one of the first motion picture data and second motion picture data is subjected to a predetermined adjusting process.

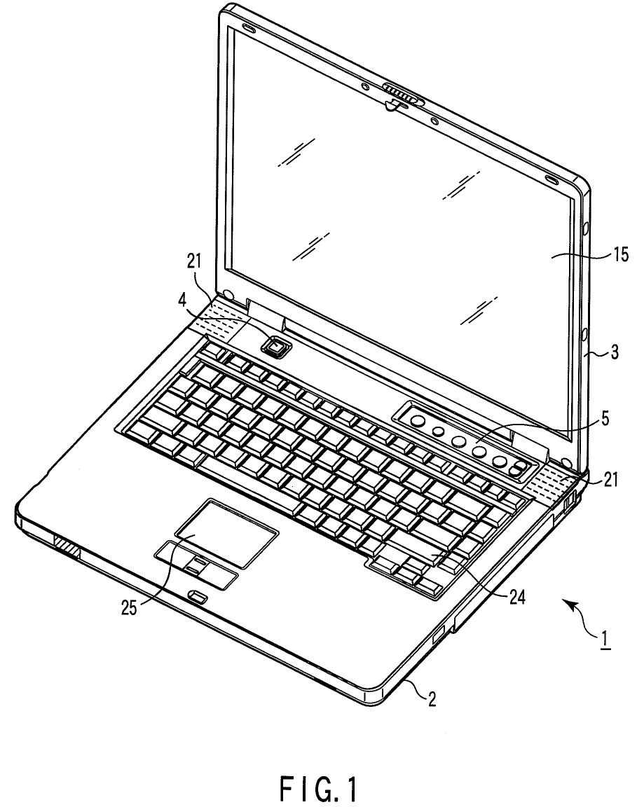

FIG. 1 is an exemplary perspective view showing the state in which the display unit of an information processing apparatus according to the embodiment is opened. For example, the information processing apparatus is realized as a notebook size personal computer 1 that can be battery-driven.

The computer 1 includes a computer main body 2 and display unit 3. In the display unit 3, a display device configured by an LCD (Liquid Crystal Display) 15 is incorporated.

The display unit 3 is rotatably mounted with respect to the computer main body 2 so as to be selectively set between an open position in which the upper surface of the computer main body 2 is exposed and a closed position in which the upper surface of the computer main body 2 is covered. The computer main body 2 has a thin box type casing and a keyboard 24, a power button 4 that sets the computer 1 in a power-on/power-off state, an input operation panel 5, speaker 21, keyboard 24, touchpad 25 and the like are arranged on the upper surface thereof.

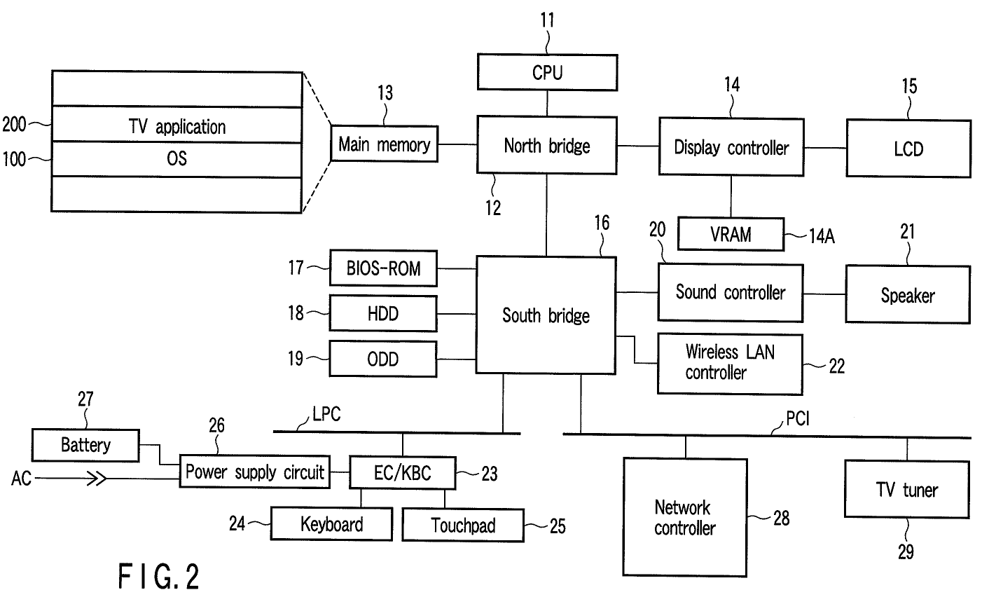

FIG. 2 is an exemplary diagram showing the system configuration of the computer 1.

As shown in FIG. 2, the computer 1 includes a CPU 11, north bridge 12, main memory 13, display controller 14, video memory (VRAM) 14A, south bridge 16, BIOS-ROM 17, hard disk drive (HDD) 18, optical disc drive (ODD) 19, sound controller 20, wireless LAN controller 22, embedded controller/keyboard controller (EC/KBC) 23, power source circuit 26, battery 27, network controller 28, TV tuner 29 and the like.

The CPU 11 is a processor that controls the operation of the computer 1 and executes an operating system (OS) 100 and various application programs including utilities executed under the control of the OS 100, that is loaded from the HDD 18 into the main memory 13. Among the various application programs, a TV application 200 that provides a television (TV) function of recording and playing back broadcast program data broadcast according to a television broadcast signal is contained.

Further, the CPU 11 executes BIOS stored in the BIOS-ROM 17. The BIOS is a program used for hardware control.

The north bridge 12 is a bridge device that connects the south bridge 16 to a local bus of the CPU 11. The north bridge 12 includes a function of communicating with the display controller 14 via a bus and contains a memory controller that controls access to the main memory 13. The display controller 14 controls the LCD 15 used as a display device of the computer 1.

The south bridge 16 is a controller that controls various devices on PCI and LPC buses. The south bridge 16 is directly connected to the BIOS-ROM 17, HDD 18, ODD 19, sound controller 20 and wireless LAN controller 22 and has a function of controlling the above devices.

The HDD 18 is a storage device that stores various softwares and data items. The ODD 19 is a drive unit that drives a storage medium such as an HD DVD in which video image content is stored. The sound controller 20 is a sound source controller that controls a speaker 21. The wireless LAN controller 22 is a wireless communication device that performs the wireless communication of the IEEE 802.11 standard, for example.

The EC/KBC 23 is a one-chip microcomputer in which an embedded controller for power management and a keyboard controller that controls the keyboard 24 and touchpad 25 are integrated. The EC/KBC 23 supplies and controls power from the battery 27 or the external AC power source to various portions in cooperation with the power source circuit 26.

The network controller 28 is a communication device that performs the communication with the external network such as the Internet, for example. The TV tuner 29 is a reception device that receives broadcast program data broadcast according to a television broadcast signal.

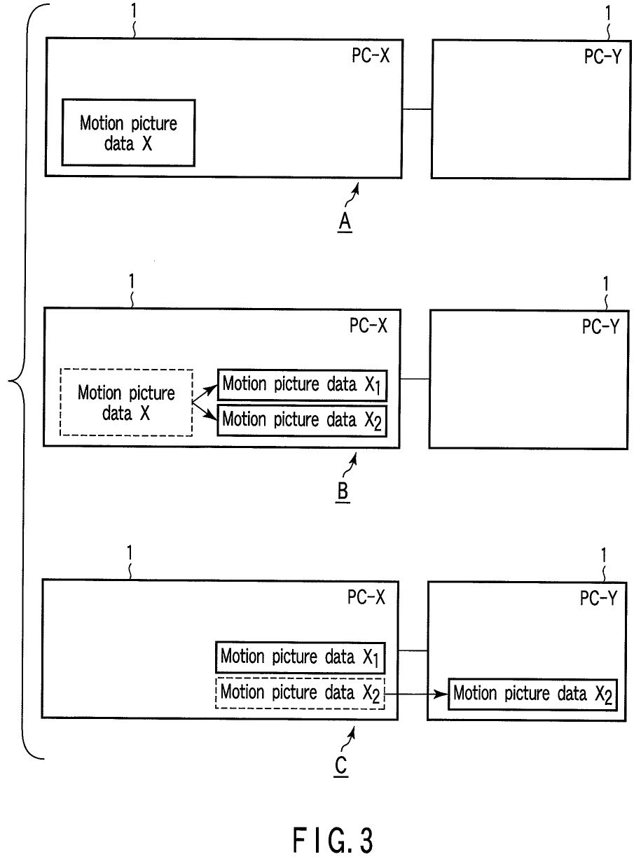

Next, the outline of a dividing function of motion picture data provided as one function among the TV functions by the TV application 200 executed on the computer 1 with the above system configuration is explained with reference to FIG. 3.

It is now assumed as shown in “A” of FIG. 3 that two computers PC-X and PC-Y are provided and motion picture data X is stored in the computer PC-X. Each of the two computers PC-X and PC-Y is the computer 1 with the system configuration shown in FIG. 2 and has the TV application 200 loaded therein. The two computers PC-X and PC-Y are set in a state in which they can transmit or receive various data items via the wireless LAN controller 22 or network controller 28.

The motion picture data X stored in the computer PC-X is permitted to move between the information processing apparatus and another electronic apparatus, but is limited from being completely copied (for example, the number of copying operations is limited). The user may consider that he wants to freely play back the motion picture data X by use of either the computer PC-X or the computer PC-Y. Therefore, in order to meet the requirement, the TV application 200 executed on the computer PC-X side first divides the motion picture data X into motion picture data X₁ formed of only odd-numbered frames and motion picture data X₂ formed of only even-numbered frames as shown in “B” of FIG. 3, for example, and then transmits one of the motion picture data items (in this example, motion picture data X₂) to the computer PC-Y as shown in “C” of FIG. 3.

The TV application 200 on the computer PC-X side plays back the motion picture data X₁ while it performs the adjusting operation of doubling the display time for each frame in comparison with the display time of a case wherein the motion picture data X before division is played back. Likewise, the TV application 200 on the computer PC-Y side also plays back the motion picture data X₂ while it performs the adjusting operation of doubling the display time for each frame in comparison with the display time of a case wherein normal motion picture data is played back.

When the state of the two computers PC-X and PC-Y after dividing the motion picture data X (the state of “C” of FIG. 3) is observed, the same frame is not provided in the motion picture data X₁ and motion picture data X₂ and the two computers PC-X and PC-Y will not have the same motion picture data. That is, only part of the motion picture data is moved and the motion picture data is not copied. Therefore, the restriction imposed on the motion picture data X that it is permitted to move between the information processing apparatus and another electronic apparatus, but is limited from being completely copied is not violated.

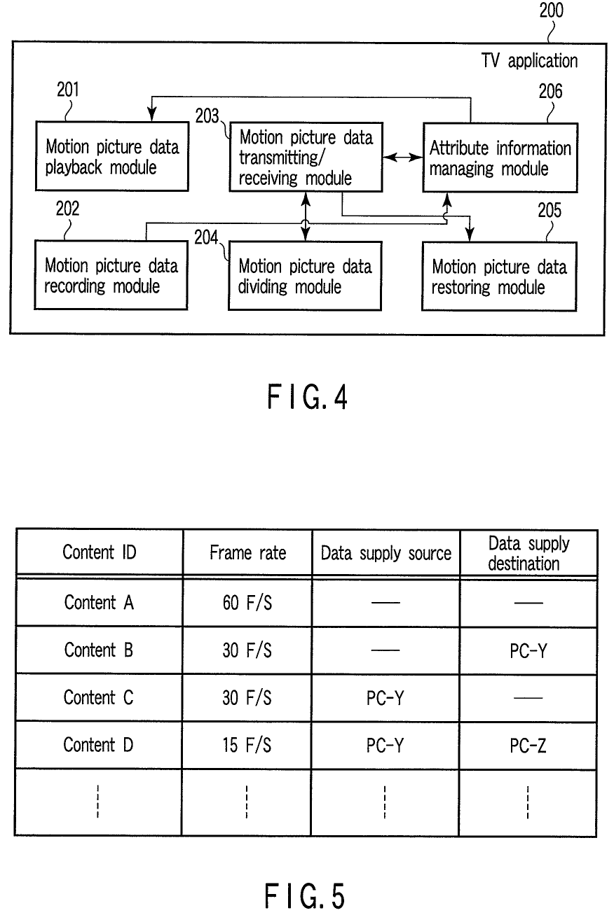

FIG. 4 is an exemplary diagram showing a function block of the TV application 200.

As shown in FIG. 4, the TV application 200 includes a motion picture data playback module 201, motion picture data recording module 202, motion picture data transmitting/receiving module 203, motion picture data dividing module 204, motion picture data restoring module 205, attribute information managing module 206 and the like.

The motion picture data playback module 201 decodes encoded broadcast program data received by the TV tuner 29, supplies picture data obtained by decoding the broadcast program data to the display controller 14 to display the same on the LCD 15 and supplies sound data obtained by decoding the broadcast program data to the sound controller 20 to output the same from the speaker 21. Further, the motion picture data playback module 201 can read out encoded broadcast program data from the HDD 18, decode the same and output picture data and sound data obtained by the decoding operation from the LCD 15 and speaker 21, respectively. The operation of storing the encoded broadcast program data into the HDD 18 is performed by the motion picture data recording module 202.

The motion picture data recording module 202 provides a so-called recording function of causing broadcast program data of the specified date and time and specified channel to be received by the TV tuner 29 and stored into the HDD 18. Starting of the recording function can be made not only by previously specifying the date and time and channel but also by specifying broadcast program data that is now viewed by use of the motion picture data playback module 201.

The motion picture data transmitting/receiving module 203 transmits motion picture data stored into the HDD 18 by the motion picture data recording module 202 to another computer 1, receives motion picture data from the other computer 1 and stores the same into the HDD 18. When the motion picture data stored in the HDD 18 is transmitted to the other computer 1, the motion picture data transmitting/receiving module 203 requests the motion picture data dividing module 204 to divide to-be-transmitted motion picture data. When motion picture data that was divided in the past by the motion picture data dividing module 204 is received from the other computer 1, the motion picture data transmitting/receiving module 203 requests the motion picture data restoring module 205 to restore the divided motion picture data.

Then, the attribute information managing module 206 manages information relating to various motion picture data items stored in the HDD 18 as attribute information on the HDD 18. FIG. 5 is an exemplary diagram showing attribute information managed by the attribute information managing module 206.

As shown in FIG. 5, the attribute information of each motion picture data is recorded on the HDD 18 in a table form containing a plurality of fields such as “content ID”, “frame rate”, “data supply source” and “data supply destination”. The attribute information shown in FIG. 5 is provided in the PC-X computer 1.

Broadcast program data received by the TV tuner 29 has a frame of 60 F/S (60 frames for each second). Content A is set in an initial state in which data is recorded in the HDD 18 by the motion picture data recording module 202 and keep the frame rate of 60 F/S. Since the state is the initial state, no data is recorded in the “data supply source” column and “data supply destination” column.

Content B is set in a state in which they are divided by the motion picture data dividing module 204 after being recorded on the HDD 18 by the motion picture data recording module 202 and then one of the divided data items is transmitted to the other computer 1 (PC-Y) by use of the motion picture data transmitting/receiving module 203. Therefore, 30 F/S is recorded in the “frame rate” column and “PC-Y” is recorded in the “data supply destination” column. At the time of playback of content B, the motion picture data playback module 201 performs the adjusting operation of doubling the display time for each frame.

On the other hand, content C is set in a state in which they are received from the other computer 1 (PC-Y) by the motion picture data transmitting/receiving module 203 and stored in the HDD 18. Therefore, 30 F/S is recorded in the “frame rate” column and “PC-Y” is recorded in the “data supply source” column. Further, content D is set in a state in which they are divided by the motion picture data dividing module 204 after being received from the other computer 1 (PC-Y) by the motion picture data transmitting/receiving module 203 and recorded on the HDD 18 and then one of the divided data items is transmitted to the other computer 1 (PC-Z) by the motion picture data transmitting/receiving module 203. Therefore, 15 F/S is recorded in the “frame rate” column, “PC-Y” is recorded in the “data supply source” column and “PC-Z” is recorded in the “data supply destination” column. At the time of playback of content D, the motion picture data playback module 201 performs the adjusting operation of multiplying the display time for each frame by 2×2=4.

Due to the presence of the attribute information, the playback operation of respective content by use of the motion picture data playback module 201 can be performed without causing any problem and the restoring operation by the motion picture data restoring module 205 can be performed when divided content B or D is returned from the other computer 1 (PC-Y, PC-Z).

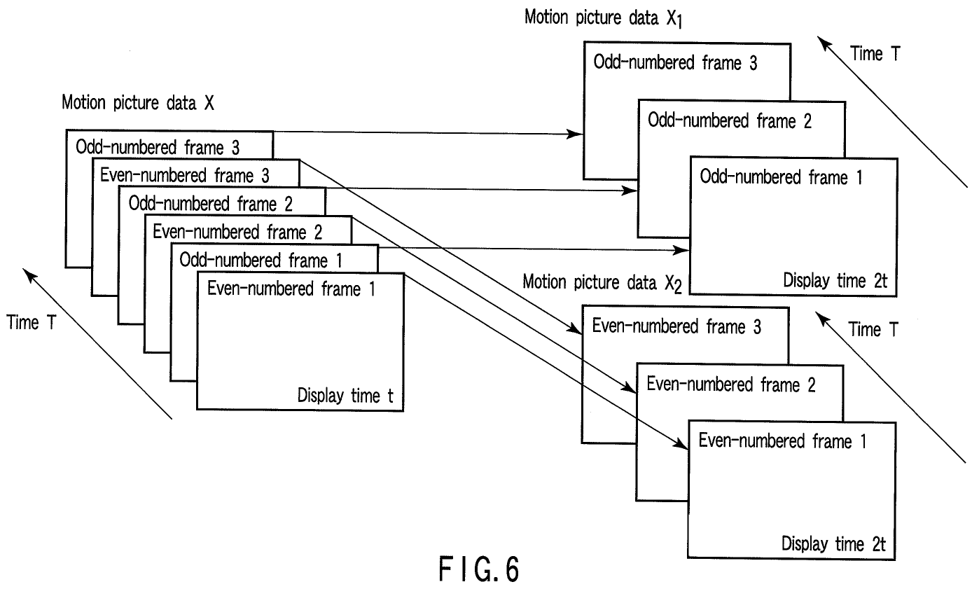

FIG. 6 is an exemplary conceptual diagram showing the basic principle of division of motion picture data performed by the motion picture data dividing module 204 of the TV application 200.

When it is assumed that motion picture data X stored in the HDD 18 by the motion picture data recording module 202 is divided, the motion picture data dividing module 204 divides the motion picture data X into motion picture data X₁ formed of only odd-numbered frames and motion picture data X₂ formed of only even-numbered frames by alternately extracting frames that are successive in time as shown in FIG. 6. The display time of each frame of the motion picture data X₁ and motion picture data X₂ after division is set equal to twice (2t) the display time t at the time of playback of original motion picture data X to maintain consistency as a whole.

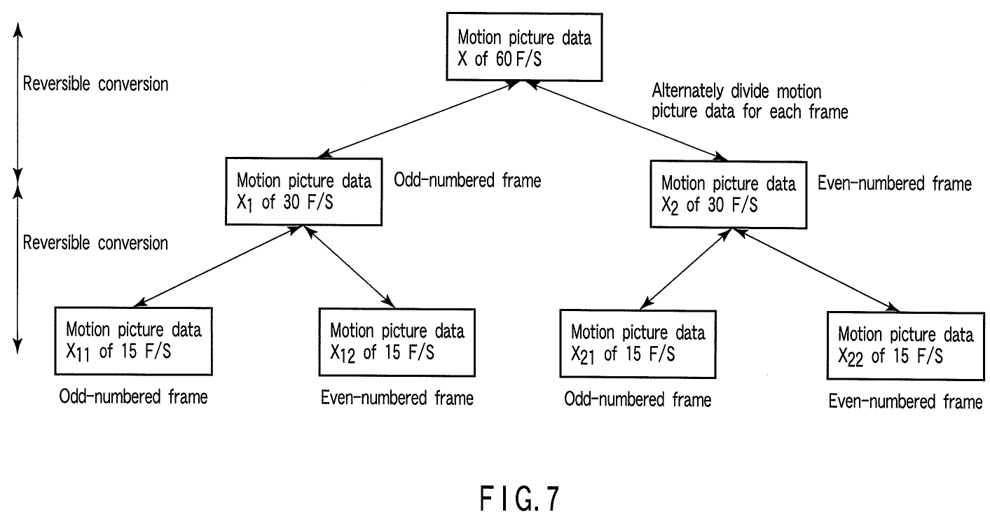

Thus, by dividing the motion picture data, the restoring operation by the motion picture data restoring module 205, that is, the reversible converting operation of the motion picture data can be performed as shown in FIG. 7. More specifically, the motion picture data X can be divided into motion picture data X₁ and motion picture data X₂ and the motion picture data X₁ and motion picture data X₂ can be respectively divided into motion picture data X₁₁, motion picture data X₁₂ and motion picture data X₂₁, motion picture data X₂₂. Then, the thus divided motion picture data X₁₁, motion picture data X₁₂ and motion picture data X₂₁, motion picture data X₂₂ can be restored into the motion picture data X₁ and motion picture data X₂ by the motion picture data restoring module 205 and the motion picture data X₁ and motion picture data X₂ can be further restored into the motion picture data X.

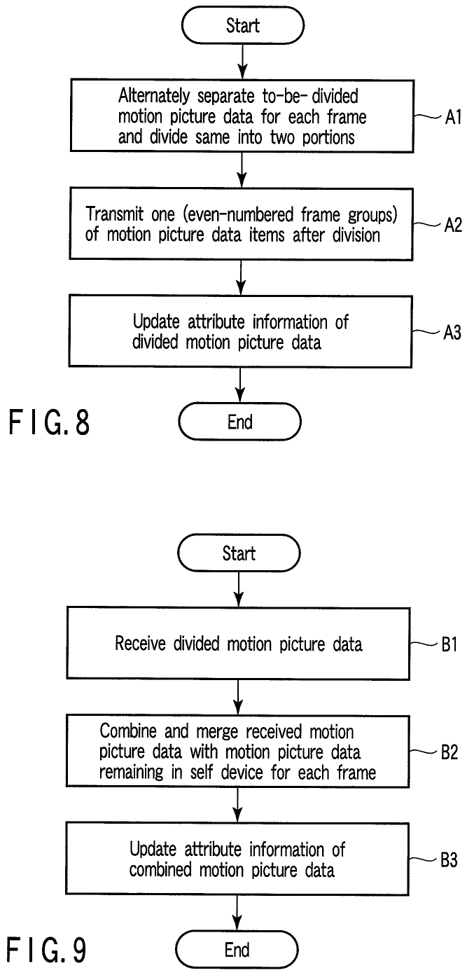

FIGS. 8 and 9 are exemplary flowcharts for illustrating the operation procedures of the TV application 200 executed on the computer 1. FIG. 8 shows the procedure at the time of division of motion picture data and FIG. 9 shows the procedure at the time of restoration of motion picture data.

At the time of division of motion picture data, the motion picture data dividing module 204 alternately separates to-be-divided motion picture data for each frame and divides the same into two portions (block A1 in FIG. 8). The motion picture data transmitting/receiving module 203 transmits one of the motion picture data items divided into two portions by the motion picture data dividing module 204 to the other computer 1 (block A2 in FIG. 8) and updates attribute information of the divided motion picture data (block A3 in FIG. 8).

At the time of restoration of motion picture data, first, the motion picture data transmitting/receiving module 203 receives the divided motion picture data from the other computer 1 (block B1 in FIG. 8). The motion picture data restoring module 205 restores the motion picture data before division by merging the received motion picture data with the motion picture data remaining on the self computer 1 side (block B2 in FIG. 8). Then, the motion picture data transmitting/receiving module 203 updates attribute information of the motion picture data restored into the state before division (block B3 in FIG. 8).

Thus, according to the computer 1, the user can enjoy motion picture data of the same content by use of a plurality of computers 1 without performing the moving and copying operations for each time.

In the above explanation, a case wherein motion picture data is divided in the frame unit is shown as an example, but motion picture data may be divided in the frequency unit, for example. More specifically, motion picture data may be subjected to the frequency conversion such as discrete Fourier transform, for example, and is divided into motion picture data formed only of odd frequency components and motion picture data formed only of even frequency components. At the playback time, the adjusting operation may be performed to interpolate omitted frequency components based on values of adjacent frequency components by use of a statistical operating method.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a storage device configured to store motion picture data;
a dividing module configured to divide the motion picture data stored in the storage device into first motion picture data and second motion picture data;
a transmitting module configured to transmit either the first motion picture data or the second motion picture data to an electronic apparatus; and
a display configured to display either the first motion picture data or the second motion picture data while manipulating the motion picture data displayed with a predetermined adjusting process.

2. The information processing apparatus of claim 1, wherein the dividing module is configured to divide the motion picture data stored in the storage device into odd-numbered frame groups and even-numbered frame groups as the first motion picture data and the second motion picture data respectively.

3. The information processing apparatus of claim 2, wherein the display is configured to display either the first motion picture data or the second motion picture data by doubling display time for each frame.

4. The information processing apparatus of claim 1, wherein the dividing module is configured to transform the motion picture data stored in the storage device into a frequency domain and to extract as an odd frequency component and an even frequency component of the motion picture data stored in the storage as the first motion picture data and the second motion picture data respectively.

5. The information processing apparatus of claim 4, wherein the display is configured to display either the first motion picture data or the second motion picture data by obtaining a value of an omitted frequency component by interpolating with values of adjacent frequency component.

6. The information processing apparatus of claim 1, further comprising:
a receiving module configured to receive the transmitted motion picture data from the transmitting module of the electronic apparatus; and
a restoring module configured to restore original motion picture data from the received motion picture data by the receiving module and a motion picture data not transmitted by the transmitting module and remained in the storage device.

7. A motion picture data processing method of an information processing apparatus comprising a storage device to store motion picture data, the method comprising:
dividing the motion picture data stored in the storage device into first motion picture data and second motion picture data;
transmitting either the first motion picture data or the second motion picture data to an electronic apparatus; and
displaying either the first motion picture data or the second motion picture data while manipulating the motion picture data displayed with a predetermined adjusting process.

8. The motion picture data processing method of claim 7, further comprising:
receiving the transmitted motion picture data from the electronic apparatus; and
restoring original motion picture data from the received motion picture data and a motion picture data not transmitted and remained in the storage device.
